(19) United States
(12) Patent Application Publication
(10) Pub. No.: US 2022/0200411 A1
(43) Pub. Date: Jun. 23, 2022

(54) ELECTRIC MACHINE

(71) Applicant: Schaeffler Technologies AG & Co. KG, Herzogenaurach (DE)

(72) Inventors: Christian Silvery, Walzbachtal (DE); Mike Czerlewitz, Bühl (DE)

(73) Assignee: Schaeffler Technologies AG & Co. KG, Herzogenaurach (DE)

(21) Appl. No.: 17/606,162

(22) PCT Filed: Mar. 26, 2020
(86) PCT No.: PCT/DE2020/100243

§ 371 Date: Oct. 25, 2021

(30) Foreign Application Priority Data
Apr. 26, 2019 (DE) 10 2019 110 865.9
Aug. 6, 2019 (DE) 10 2019 121 190.5

(51) Int. Cl. H02K 11/25; H02K 3/50

(52) U.S. Cl. CPC H02K 11/25; H02K 2203/09; H02K 3/50

(57) ABSTRACT

An electric machine includes a stator having a winding having a first plurality of conductors, and at least one temperature sensor arrangement including a temperature sensor for detecting the temperature in the region of the winding. The ends of at least one part of the first plurality of conductors protrude from the winding. One part of said ends is connected to an axial or radial interconnection ring placed on the winding that includes a second plurality of conductors. The temperature sensor arrangement is arranged on or in the interconnection ring and the temperature sensor is thermally coupled to at least one conductor of the second plurality of conductors.

### CROSS-REFERENCE TO RELATED APPLICATIONS

This application is the U.S. National Phase of PCT Appin. No. PCT/DE2020/100243 filed Mar. 26, 2020, which claims priority to DE 102019110865.9 filed Apr. 26, 2019 and DE 102019121190.5 filed Aug. 6, 2019, the entire disclosures of which are incorporated by reference herein.

### TECHNICAL FIELD

The disclosure relates to an electric machine comprising a stator having a winding and at least one temperature sensor arrangement comprising a temperature sensor for detecting the temperature in the region of the winding.

### BACKGROUND

Electric machines comprise a rotor and a stator and are used in different areas of application. The use of electric machines for electric hybrid vehicles and electric vehicles, or for hub drives is to be mentioned only as an example. If such an electric machine is used as a drive machine, it is usually designed as an internal rotor, i.e., the stator surrounds the internal rotor. A moving magnetic field is generated via the stator, which causes the rotor to rotate. For this purpose, the stator has a winding consisting of a large number of conductors, wherein the conductors are assigned to one or usually more than phase. The winding is guided around the stator teeth in a manner known per se.

Not only the number of phases is included in the design of the winding geometry, but also the number of wires per phase as well as the number of wires per slot within the stator toothing and the number of pole pairs. This variety of conductors and winding parameters creates a complex network of conductors that is built up using different winding technologies. Examples include hairpin or bar wave windings. Here, the conductors are formed by means of rods bent into a U-shape, which are put together to form a winding cage. The conductors are laid on a plurality of radial planes, wherein the conductors move from plane to plane, so to speak. To form these meandering, so to speak, circumferential conductors, they are to be connected accordingly at their ends, which is usually done by welding the conductor ends that are adjacent to one another. The conductor ends converge at one point or on one winding side in the form of the so-called star, where they are connected to one another. In this region, the connection of the individual phases to an external power supply, i.e., a power connection that is used to generate the magnetic field, is to be made.

During the operation of the electric machine, the temperature of individual components must be monitored, including appropriate temperature sensors can be used, PTC or NTC sensors. One region in which the temperature is to be recorded is that of the winding, since one of the hottest points of the stator of the electric machine prevails in the region of the winding, where a temperature sensor can be installed. The hottest point of the stator is namely in the hairpin or bar wave winding region, specifically in the axial center of the laminated core. However, since this point cannot be reached in order to integrate a temperature sensor, the outer region of the winding is selected. For this purpose, the temperature sensor is installed inside the stator, which means that it usually has to be installed at an early stage of the production process. In order to detect the temperature in the winding region as precisely as possible, it is desirable to install the temperature sensor as close as possible to or on the winding or the winding head, since media flowing in the interior, for example water, air, oil, etc., can impair the temperature measurement and the measurement therefore becomes inaccurate as the distance between the temperature sensor and the winding or the winding head increases. The arrangement of the temperature sensor, in particular on a particularly tightly wound or compactly wound winding, such as a hairpin or a bar wave winding, is particularly complicated.

### SUMMARY

The disclosure is based on the problem of specifying an electric machine that is improved in comparison.

To solve this problem, in an electric machine of the type mentioned, the disclosure provides that the ends of at least some of the conductor protrude from the winding, wherein on part of said ends is connected to an axial or radial interconnection ring placed on the winding, wherein the temperature sensor arrangement arranged on or in the interconnection ring and the temperature sensor is thermally coupled to at least one conductor.

The electric machine according to the disclosure provides for the temperature sensor to be arranged directly on the interconnection ring, so that the temperature of a conductor there, which, appropriately connects winding conductors as a conductor bridge, as it were, is measured via the temperature sensor. This makes it possible to detect the temperature not only in a radially or axially outer region of the stator winding, which can be subjected to a different operating temperature due to increased heat dissipation, but rather integrated in the interconnection ring directly in the region of the point of origin. Due to the integration of the temperature detection in the interconnection ring itself, an optimal heat transfer between the current-carrying and therefore heating conductor, i.e., the busbar or cable bridge, usually a copper bar, and the temperature sensor is achieved, so that undesired error influences and measured value deviations are reliably avoided. In addition, due to the integration in the interconnection ring, which is a separately configurable element to be placed on the winding as an independent component, the radial and axial position of the temperature sensor can be defined reliably and with reproducible accuracy.

The interconnection ring expediently has a housing in which the conductor is received, wherein the temperature sensor arrangement is arranged on or in the housing. The arrangement of the temperature sensor arrangement on or in the housing ensures the simple and, in particular, reproducible fixing of the temperature sensor arrangement in a simple manner, since a defined fastening interface can be implemented. In particular, the arrangement in the housing also provides protection against any external influences, so that, for example, no media flows such as water, air, oil, etc. can reach the temperature sensor, which can be an NTC or PTC resistance element, for example.

The temperature sensor arrangement itself preferably comprises a carrier, wherein the temperature sensor is arranged in the region of a carrier side. The temperature sensor arrangement will lose sufficient stability via this carrier. The temperature sensor itself can be arranged on a sensor carrier which is arranged on the carrier. This sensor carrier, for example an elongated plate made of plastic, for example, is used to securely fix the temperature sensor. The temperature sensor is also interconnected on the sensor carrier via suitable connecting lines to form a continuing cable.

For a secure and positionally accurate fixation of the sensor carrier on the carrier itself, the carrier preferably has a receptacle that is compatible with the shape of the sensor carrier and into which the sensor carrier can be inserted in a form-fitting manner.

According to a particularly advantageous development, the carrier itself forms part of a housing, wherein the temperature sensor is positioned on an open side of the housing.

According to an advantageous development of the disclosure, it can be provided that the temperature sensor is spring-loaded against the conductor via at least one spring element. This spring element, which acts on the carrier, for example, ensures that the temperature sensor is always pressed into thermal contact with the conductor, i.e., the copper bridge, and thus a reproducible thermal coupling for exact temperature detection is always ensured.

It is particularly preferred that a cover is provided which can be detachably connected to the carrier, wherein the carrier can be moved relative to the cover and the spring element is arranged between the cover and the carrier. This cover forms, as it were, a second part of the housing, wherein in particular it has the function of an abutment for the spring element. The spring element is tensioned between the cover and the carrier. The temperature sensor or the sensor carrier is arranged on the opposite carrier side, exposed to the outside of the housing, so that the carrier that is movable relative to the cover and thus also the sensor is pressed against the conductor of the interconnection ring.

Alternatively, it is conceivable that the spring element is also arranged between the carrier and the sensor carrier itself. In this case, the carrier forms the abutment for the spring element; a housing-like cover is not provided here. In this case, the carrier is to be fixed in a fixed position directly in a suitable manner, in contrast to the embodiment described above, in which the cover is to be fixed in a fixed position after the carrier can be moved relative to the cover.

A curved leaf spring, which is preferably fixed to the carrier, is preferably used as the spring element, if provided, but can also be fastened to the cover.

To fix the temperature sensor arrangement on or in the interconnection ring or its housing, a latching or clamping connection is particularly preferably provided for detachable fixation. This detachable fixation enables, on the one hand, assembly in a simple manner by simple locking or clamping, but simple dismantling is also possible. If a housing or a cover is used, corresponding latching projections or the like are provided on the housing or cover, which snap into corresponding latching receptacles on the interconnection ring or interconnection ring housing. Since the cover is fixed, the carrier can be moved relative to the cover. If no cover is used, but only a carrier, this must be fixed on the interconnection ring side by means of corresponding latching elements, since the sensor carrier can then be moved relative to the carrier for springing, provided that such a spring element is provided in this case, which is not mandatory.

### BRIEF DESCRIPTION OF THE DRAWINGS

The disclosure is explained below on the basis of exemplary embodiments with reference to the drawings. The drawings are schematic representations, wherein:

FIG. 1 shows a schematic diagram in the form of a partial view of an electric machine according to the disclosure,

FIG. 2 shows a perspective view of a temperature sensor device with temperature sensor and sensor carrier,

FIG. 3 shows an exploded representation of a carrier and a spring element,

FIG. 4 shows the assembled arrangement of carrier and spring element,

FIG. 5 shows the arrangement from FIG. 4 with the temperature sensor device fastened thereto,

FIG. 6 shows an exploded representation of the arrangement from FIG. 6 with an additional cover,

FIG. 7 shows a sectional view through the mounted temperature sensor arrangement from FIG. 6 with the cover attached,

FIG. 8 shows a detailed view of the interconnection ring with the temperature sensor arrangement not yet fastened, and

FIG. 9 shows a sectional view through the arrangement from FIG. 8 with a fixed temperature sensor arrangement.

### DETAILED DESCRIPTION

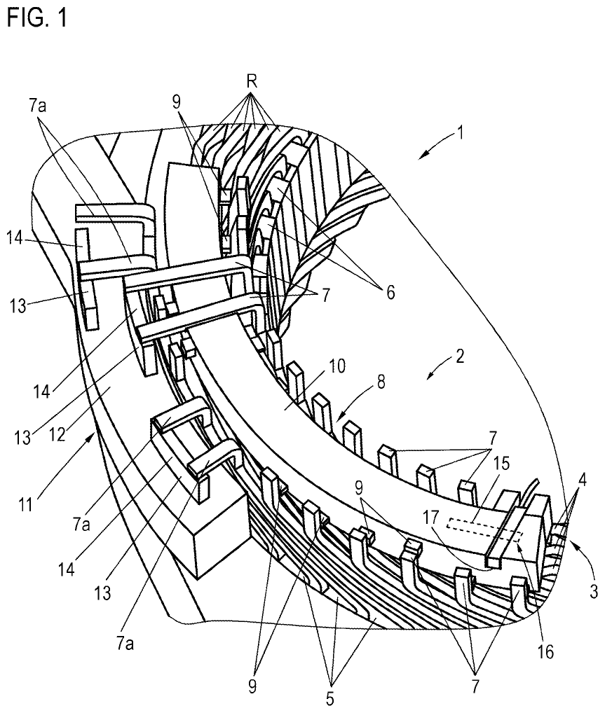

FIG. 1 shows, in the form of a partial view, a schematic diagram of an electric machine 1 according to the disclosure, comprising a stator 2 having a winding 3 comprising a plurality of conductors 4, which are assigned to three separate phases in the example shown. Each conductor 4 is designed almost like a U-shaped bracket, wherein a plurality of such U-shaped conductors, often also called hairpins, are plugged together to form the winding 3, which can also be referred to as a winding cage. The plurality of conductors 4 defines different radial planes R, as shown in FIG. 1. For this purpose, the conductors 4 extend, depending on the winding diagram, from one radial plane to another radial plane, for example an adjacent radial plane, in the region in which they are connected to the conductor ends of corresponding adjacent conductors continuing the phase conductor.

The conductors 4 are guided or bent and laid in such a way that corresponding recesses 5 result, which extend radially so that corresponding stator teeth 6 engage in these recesses 5 or the corresponding conductors 4 are wound between the grooves of the stator teeth 6. The basic structure of such a stator 2 or a winding 3 wound from the separate brackets described is basically known.

In the stator 2 according to the disclosure, the ends 7 of the conductors 4, insofar as the ends 7 terminate respectively at the inner circumference and/or the outer circumference of the annular winding 3, are axially protruding, i.e., they protrude axially from the winding 3. These ends 7 are associated with individual conductors 4, which in turn are assigned to different phases, which is why the conductor ends must be connected according to the routing diagram of the conductor 4. For this purpose, an interconnection ring 8 is used, which, in this example, is placed axially on the end face of the winding 3 and is arranged between the conductor ends 7 or engages therebetween. The interconnection ring 8 comprises, as will be discussed below, one or several corresponding conductors in the form of line bridges, and connection sections 9, which protrude to the side from the housing 10 of the interconnection ring 8 and are positioned precisely next to the corresponding conductor end 7 after the interconnection ring 8 has been inserted between the conductor ends 7 with which they are to be connected. The connection is made by simple welding so that all conductors 4 are correctly and phase-specifically interconnected when they are connected.

Furthermore, a power supply 11 is provided, which is arranged radially next to the winding 3 in the region of its axial end, i.e., of the winding head. The power supply 11, also referred to as an HV terminal, comprises a housing 12, in which corresponding busbars 13 are arranged, which protrude with their connection terminals 14 from the housing 12.

In the present case, as described, a three-phase stator is shown, which is why three such connection terminals 14 are also provided in the example shown.

Each connection terminal 14 is to be connected to one phase of the winding 3. This is implemented in a simple manner in the exemplary embodiment shown in that two conductor ends 7a per phase are guided or bent radially outwards, as FIG. 1 illustrates.

As already described, one or a plurality of conductors 15 is accommodated in the interior of the housing 10 of the interconnection ring 8, which conductors serve as line bridges and are designed in the form of conductor rails or busbars. In the example shown, only one such conductor 15 is shown in dashed lines. According to the disclosure, a temperature sensor arrangement 16 is also provided, which is received on or in the housing 10 of the interconnection ring 8, for which purpose in the example shown only a recess 17 is shown in principle, in which the temperature sensor arrangement 16 is inserted. The arrangement is such that a temperature sensor, which will be discussed below, is brought into thermal contact with a conductor 15, preferably the neutral conductor, so that its temperature is measured, which can be used to obtain information about the winding temperature. This means that the arrangement according to the disclosure of the temperature sensor arrangement 16 on or in the interconnection ring or its housing itself enables a direct temperature measurement at this location.

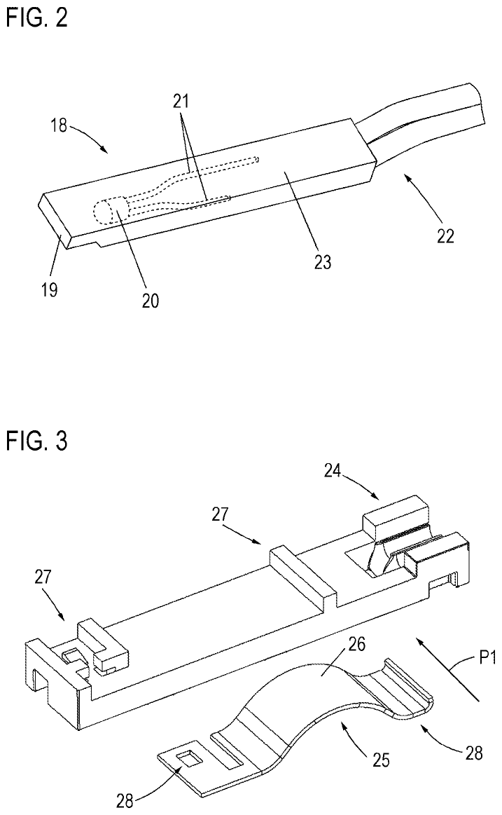

FIG. 2 shows a temperature sensor device 18 as part of the temperature sensor arrangement 16. The temperature sensor device 18 comprises a sensor carrier 19 on which the actual temperature sensor 20, for example an NTC or PTC sensor, is fastened and is connected to a corresponding continuing cable 22 via connecting lines 21. A shrink tube 23 is pulled over the sensor carrier 19 and the temperature sensor 20 as well as the connecting line 21 in order to protect the arrangement. The sensor carrier 19 is elongated, i.e., in the form of a plate, for example it is a plastic plate.

FIG. 3 shows an exploded representation of a carrier 24 and a spring element 25 in the form of a leaf spring 26. As will be discussed below, the carrier 24 receives and holds the temperature sensor device 18 from FIG. 2.

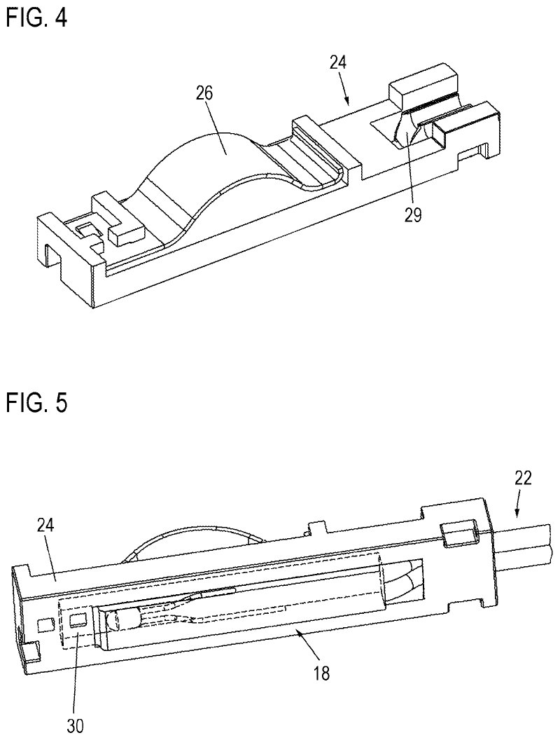

On one side of the carrier 24, fastening means 27 are provided for the arrangement and fastening of the leaf spring 26, which likewise has corresponding fastening means 28 in the form of latching elements or corresponding form-fitting elements. As shown by the arrow P1, the leaf spring 26 is pushed onto the carrier 24 from the side so that, on the one hand, it is tensioned between the fastening means 27 there but, on the other hand, it is also locked in place, as FIG. 4 shows.

This arrangement from FIG. 4 is then equipped with the temperature sensor device 18, see FIG. 5. For this purpose, the sensor carrier 19 is passed through an insertion opening 29 provided on the carrier so that it is positioned on the outer lower side of the carrier 24, as it were, which has a corresponding recess 30 for receiving the sensor carrier. As FIG. 5 shows, the cable 22 runs out of the insertion opening 29 and can be continued. This means that after it has been arranged on the carrier 24, the temperature sensor 20 is arranged in the region of the open underside.

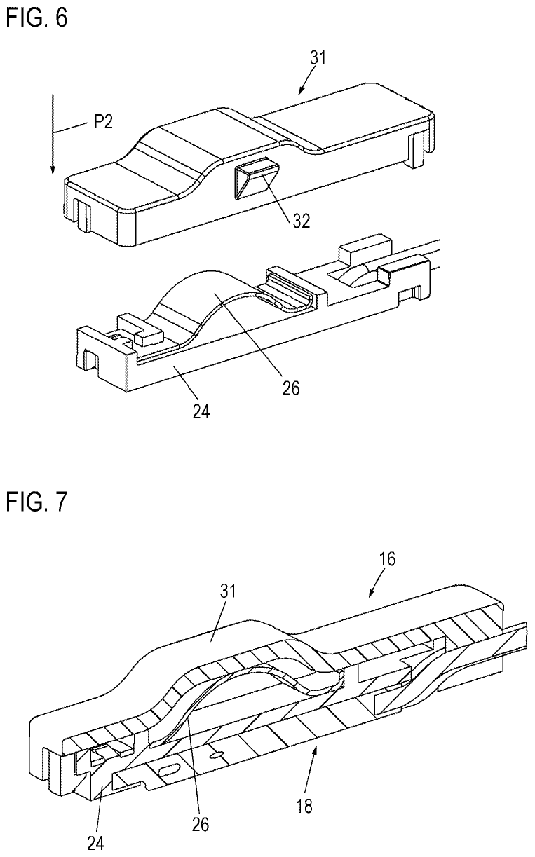

FIG. 6 also shows a cover 31, which is to be snapped onto the carrier 24 via a suitable latching connection, not shown in detail, in an exploded view. Like the carrier 24, the cover 31 is also made of plastic. The cover can be seen, see arrow P2, on the side on which the leaf spring 26 is arranged, so that after the cover 31 has been mounted, see FIG. 7, the leaf spring 26 is tensioned between the cover 31 and the carrier 24. The carrier 24 can be moved somewhat relative to the cover 31, as far as its latching connection permits. This is necessary because the sensor carrier 19 or the temperature sensor 20 is spring-loaded and pressed against the conductor 15 via the leaf spring 26.

On the cover 31, see FIG. 6, corresponding latching elements 32 are provided on both sides (FIG. 6 shows only one side thereof), via which latching elements 32 the cover 31 and with it the entire temperature sensor arrangement 16, as shown in FIG. 7 is fixed on the interconnection ring 8 or its housing 10.

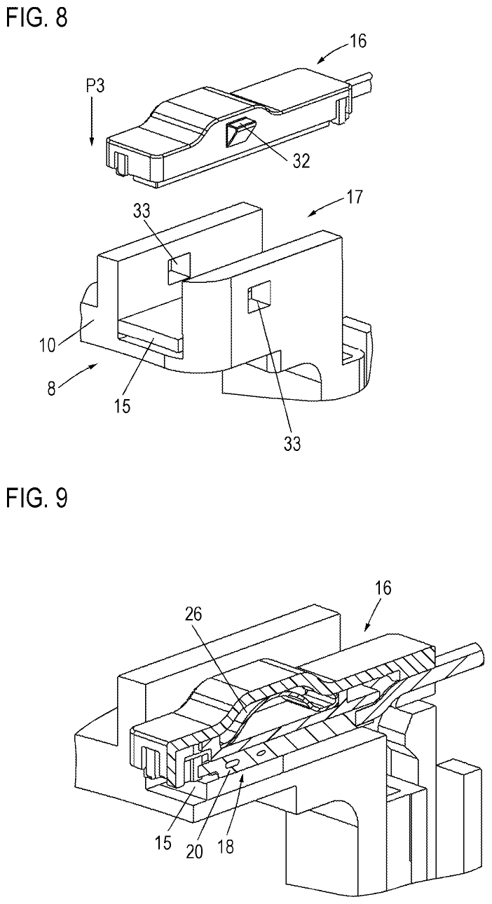

This process is shown in FIG. 8. This shows a section of the interconnection ring 8 or its housing 10, with the recess 17 already mentioned above, into which the temperature sensor arrangement 16, as shown by the arrow P3, is inserted. In the region of the recess 17, the conductor 15, for example the neutral conductor, is exposed. If the temperature sensor arrangement 16 is now pressed into the recess 17, the latching elements 32 snap into suitable latching receptacles 33 on the housing 10 in the region of the recess 17 when the final assembly position is reached, whereby the temperature sensor arrangement 16 is fixed in position on the one hand, but also released again if necessary and can be removed or replaced for maintenance.

After the latching connection has been snapped in, the temperature sensor arrangement 16 is fixed in a reproducible manner with precise positioning, see FIG. 9. The temperature sensor device 18 or the temperature sensor 20 is spring-loaded against the conductor 15 via the leaf spring 26, as FIG. 9 clearly shows, so that there is an optimal thermal contact and thus a very good thermal coupling. By springing the temperature sensor, on the one hand, a reproducible thermal contact can be achieved, and on the other hand, corresponding geometric tolerances can easily be compensated for. At the same time, the measuring arrangement is also protected against external influences such as media flows, etc. due to the encapsulation in the housing or the corresponding arrangement on the interconnection ring housing.

### LIST OF REFERENCE SYMBOLS

1 Electric machine

2 Stator

3 Winding

4 Conductor

5 Recess

6 Stator tooth

7 Conductor end

8 Interconnection ring

9 Connection section

10 Housing

11 Power supply

12 Housing

13 Conductor rail

14 Connection terminal

15 Conductor

16 Temperature sensor arrangement

17 Recess

18 Temperature sensor device

19 Sensor carrier

20 Temperature sensor

21 Connecting line

22 Cable

23 Shrink tube

24 Carrier

25 Spring element

26 Leaf spring

27 Fastening means

28 Fastening means

29 Insertion opening

30 Recess

31 Cover

32 Latching element

33 Latching receptacle

R Radial plane

P1 Arrow

P2 Arrow

P3 Arrow

1. An electric machine comprising a stator having a winding including a first plurality of conductors and at least one temperature sensor arrangement comprising a temperature sensor for detecting a temperature in a region of the winding wherein ends of at least some of the conductors protrude from the winding, wherein one part of said ends is connected to an axial or radial interconnection ring placed on the winding, wherein the interconnection ring includes a second plurality of conductors and the temperature sensor arrangement is arranged on or in the interconnection ring and the temperature sensor is thermally coupled to at least one conductor of the second plurality of conductors.

2. The electric machine according to claim 1, wherein the interconnection ring has a housing in which the second plurality of conductors are received, wherein the temperature sensor arrangement is arranged on or in the housing.

3. The electric machine according to claim 1, wherein the temperature sensor arrangement comprises a carrier, wherein the temperature sensor is arranged in a region of a carrier side.

4. The electric machine according to claim 3, wherein the temperature sensor is arranged on a sensor carrier which is arranged on the carrier.

5. The electric machine according to claim 4, wherein a receptacle compatible with a shape of the sensor carrier is provided on the carrier.

6. The electric machine according to claim 4, wherein the carrier forms part of a housing, wherein the temperature sensor is positioned on an open side of the housing.

7. The electric machine according to claim 4, wherein the temperature sensor is spring-loaded against the second plurality of conductors via at least one spring element.

8. The electric machine according to claim 7, wherein a cover detachably connected to the carrier is provided, wherein the carrier is movable relative to the cover and the spring element is arranged between the cover and the carrier, or in that the spring element is arranged between the carrier and the sensor carrier.

9. The electric machine according to claim 7, wherein the spring element is a curved leaf spring which is fixed on the carrier.

10. The electric machine according to claim 1, wherein the temperature sensor arrangement is detachably arranged on the interconnection ring via a latching or clamping connection.
